(19) United States
(12) Patent Application Publication
(10) Pub. No.: US 2013/0261981 A1
(43) Pub. Date: Oct. 3, 2013

(54) COVARIANCE ESTIMATION USING SPARSE WAVELET REPRESENTATION

(71) Applicant: WESTERNGECO L.L.C., Houston, TX (US)

(72) Inventors: AIMÉ FOURNIER, HOUSTON, TX (US); KONSTANTIN S. OSYPOV, HOUSTON, TX (US)

(73) Assignee: WESTERNGECO L.L.C., Houston, TX (US)

(21) Appl. No.: 13/856,256

(22) Filed: Apr. 3, 2013

Related U.S. Application Data
(60) Provisional application No. 61/619,886, filed on Apr. 3, 2012.

(51) Int. Cl. G01V 1/30

(52) U.S. Cl. CPC G01V 1/30
USPC 702/14

(57) ABSTRACT

Computing systems and methods are disclosed. In one embodiment, a technique is provided that includes receiving data representing at least in part a structure of interest; and processing the data in a processor-based machine to represent the data as a data structure including a plurality of contiguous data segments and at least one disjoint section, which separates two of the contiguous data segments. The technique includes processing the data structure based at least in part on the disjoint section(s) exhibiting ergodic behavior to determine at least one property of the structure.

### CROSS-REFERENCE TO RELATED APPLICATION

This application claims the benefit of U.S. Provisional Patent Application Ser. No. 61/619,886 filed Apr. 3, 2012, which is incorporated herein by reference in its entirety.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array, or spread, of seismic sensor-containing streamers and sources is towed behind a survey vessel. A marine survey may also be conducted using a stationary seabed sensor cable, which is disposed on the sea floor.

Seismic surveys may also be conducted on dry land. For example, one or more seismic vibrators may be used in connection with a “vibroseis” survey. Although the seismic vibrator may impart a seismic source signal into Earth, which has a relatively lower energy level than the signal that is generated, for example, by a source in a towed marine survey, the energy that is produced by the seismic vibrator's signal lasts for a relatively longer period of time. Other types of land-based seismic surveys include, as examples, surveys that are conducted in wells, such as surveys in which one or more seismic sources are disposed at the Earth surface, and seismic receivers may be deployed in one or more downhole wells.

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In one implementation, a technique includes receiving data representing at least in part a structure of interest; and processing the data in a processor-based machine to represent the data as a data structure including a plurality of contiguous data segments and at least one disjoint section, which separates two of the contiguous data segments. The technique includes processing the data structure based at least in part on the disjoint section(s) exhibiting ergodic behavior to determine at least one property of the structure.

In another implementation, a system includes an interface to receive data representing at least in part a structure of interest; and a processor. The processor is adapted to process the data to represent the data as a data structure including a plurality of contiguous data segments and at least one disjoint section, which separates two of the contiguous data segments. The processor is adapted to process the data structure based at least in part on the disjoint section(s) exhibiting ergodic behavior to determine at least one property of the structure.

In another implementation, an article includes a non-transitory computer readable storage medium to store instructions that when executed by a computer cause the computer to receive data representing at least in part a structure of interest; process the data to represent the data as a data structure including a plurality of contiguous data segments and at least one disjoint section, which separates two of the contiguous data segments; and process the data structure based at least in part on the disjoint section(s) exhibiting ergodic behavior to determine at least one property of the structure.

In another implementation, a computing system includes a means for receiving data representing at least in part a structure of interest; and a means for processing the data to represent the data as a data structure including a plurality of contiguous data segments and at least one disjoint section, which separates two of the contiguous data segments and processing the data structure based at least in part on the disjoint section(s) exhibiting ergodic behavior to determine at least one property of the structure.

In another implementation, an information processing apparatus for use in a computing system includes a means for receiving data representing at least in part a structure of interest; and a means for processing the data to represent the data as a data structure including a plurality of contiguous data segments and at least one disjoint section, which separates two of the contiguous data segments and processing the data structure based at least in part on the disjoint section(s) exhibiting ergodic behavior to determine at least one property of the structure.

In another implementation, a system includes an interface and a processor. The interface receives data associated with a grid having a plurality of coordinates, and the data have at least one variation on the number of indices for an associated coordinate of the plurality of coordinates such that the data have an associated grid heterogeneity. The processor is adapted to process the data to organize the data with a priority along a given coordinate of the plurality of coordinates, apply a plurality of wavelet-transform factors having at least two different sizes to the data to account for the grid heterogeneity, use the application of the plurality of wavelet transforms in a matrix product and determine a covariance based at least in part on the matrix product.

In another implementation, a technique includes receiving data associated with a grid having a plurality of coordinates, where the data have at least one variation on the number of indices for an associated coordinate of the plurality of coordinates such that the data have an associated grid heterogeneity. The technique includes processing the data in a processor-based machine to organize the data with a priority along a given coordinate of the plurality of coordinates; apply a plurality of wavelet-transform factors having at least two different sizes to the data to account for the grid heterogeneity; use the application of the plurality of wavelet transforms in a matrix product; and determine a covariance based at least in part on the matrix product.

In another implementation, an article includes a computer readable storage medium to store instructions that when executed by a computer cause the computer to receive data associated with a grid having a plurality of coordinates, where the data have at least one variation on the number of indices for an associated coordinate of the plurality of coordinates such that the data have an associated grid heterogeneity; organize the data with a priority along a given coordinate of the plurality of coordinates; apply a plurality of wavelet-transform factors having at least two different sizes to the data to account for the grid heterogeneity; use the application of the plurality of wavelet transforms in a matrix product; and determine a covariance based at least in part on the matrix product.

In another implementation, a computing system includes means for receiving data associated with a grid having a plurality of coordinates, where the data have at least one variation on the number of indices for an associated coordinate of the plurality of coordinates such that the data have an associated grid heterogeneity. The computing system includes a means for processing the data to organize the data with a priority along a given coordinate of the plurality of coordinates, applying a plurality of wavelet-transform factors having at least two different sizes to account for the grid heterogeneity, using the application of the plurality of wavelet transforms in a matrix product, and determining a covariance based at least in part on the matrix product.

In another implementation, an information processing apparatus for use in a computing system includes means for receiving data associated with a grid having a plurality of coordinates, where the data have at least one variation on the number of indices for an associated coordinate of the plurality of coordinates such that the data have an associated grid heterogeneity. The apparatus includes a means for processing the data to organize the data with a priority along a given coordinate of the plurality of coordinates, applying a plurality of wavelet-transform factors having at least two different sizes to account for the grid heterogeneity, using the application of the plurality of wavelet transforms in a matrix product, and determining a covariance based at least in part on the matrix product.

In another implementation, a technique includes receiving data representing at least in part a structure of interest, where the data represent at least in part values associated with a grid and being associated with at least one missing value. The technique includes processing the data in a processor-based machine to determine at least one property of the structure of interest. The processing includes selectively weighting the data corresponding to the values based at least in part on an extent of the missing value(s).

In another implementation, a system includes an interface to receive data representing at least in part a structure of interest, where the data represents at least in part values associated with a grid and being associated with at least one missing value. The system includes a processor to determine at least one property of the structure of interest. The processor is adapted to selectively weight the data corresponding to the values based at least in part on an extent of the at least one missing value(s).

In another implementation, an article includes a non-transitory computer readable storage medium to store instructions that when executed by a computer cause the computer to receive data representing at least in part a structure of interest, where the data represents at least in part values associated with a grid and being associated with at least one missing value. The instructions when executed cause the computer to process the data to determine at least one property of the structure of interest, where the processing includes selectively weighting the data corresponding to the values based at least in part on an extent of the at least one missing value(s).

In another implementation, a computing system includes means for receiving data representing at least in part a structure of interest, where the data represent at least in part values associated with a grid and being associated with at least one missing value. The computing system includes means for processing the data to determine at least one property of the structure of interest, where the processing includes selectively weighting the data corresponding to the values based at least in part on an extent of the at least one missing value(s).

In another implementation, an information processing apparatus for use in a computing system includes means for receiving data representing at least in part a structure of interest, where the data represent at least in part values associated with a grid and being associated with at least one missing value. The apparatus includes means for processing the data to determine at least one property of the structure of interest, where the processing includes selectively weighting the data corresponding to the values based at least in part on an extent of the at least one missing value(s).

In alternative or further implementations, receiving the data includes receiving data representing at least in part sensed energy attributable to energy from at least one energy source being incident upon the structure of interest.

In alternative or further implementations, receiving the data includes receiving seismic data representing at least in part sensed energy attributable to energy from at least one energy source being incident upon a geologic structure of interest.

In alternative or further implementations, processing the data structure to determine at least property of the structure includes processing the data structure to determine at least one of a velocity or a density of the structure.

In alternative or further implementations, processing the data structure includes processing the data structure based at least in part on an assumption that the probability distribution of the contiguous data segment(s) is approximately the same as a sample distribution of the contiguous data segments(s).

In alternative or further implementations, processing the data structure includes determining a diagonal representation of a covariance of at least one tomographic residual.

In alternative or further implementations, determining the matrix product further includes using the wavelet-transform factors in lieu of eigenvector matrices of a data covariance matrix such that the wavelet-transform factors approximate the eigenvector matrices.

In alternative or further implementations, a permutation matrix is applied to organize the data with a priority along a given coordinate of the plurality of coordinates.

In alternative or further implementations, selectively weighting the data includes weighting the data so that for a given line integral, a mean square value along a coordinate compensates for the missing value(s).

In alternative or further implementations, selectively weighting the data includes selectively weighting the data based at least in part on a number of the missing value(s) over a given interval.

In alternative or further implementations, determining the property(ies) of the structure of interest includes processing the data to determine a covariance matrix.

Advantages and other features will become apparent from the following drawings, description and claims.

### BRIEF DESCRIPTION OF THE DRAWINGS

FIG. 1 is a schematic diagram of a system to acquire and process data corresponding at least in part to a subsurface three-dimensional (3-D) geologic formation according to an example implementation.

FIG. 2 is a flow diagram depicting a technique to process acquired data corresponding at least in part to a subsurface 3-D geologic formation to determine at least one property of the formation according to an example implementation.

FIG. 3 is a flow diagram depicting a technique to reorganize seismic data to be processed based on the assumption of ergodicity according to an example implementation.

FIG. 4 is a flow diagram depicting a technique to process seismic data to account for muted data according to an example implementation.

FIG. 5 is a flow diagram depicting a technique to process seismic data to account for missing data according to an example implementation.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments only and is not intended to be limiting of the invention. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Techniques and systems are disclosed herein for purposes of estimating covariance matrices for data having a relatively large size (on the order of 10⁷ to 10⁸ values, for example). As disclosed herein, the systems and techniques are applied to underlying data that may be, in a certain sense, relatively smooth for most of their values, and relatively rough mainly in compact regions. For estimation of the covariance matrices, the data are projected onto wavelet basis functions, which may be “off-the-shelf” functions (i.e., data independent), in accordance with example implementations. By projecting the data onto wavelet basis functions, operations with the covariance matrices may be performed at computational costs (i.e., costs in terms of time and/or memory) of an order of the data size, instead of the square or cube of that number as would be usual for multiplication or inversion, respectively. Moreover, the accuracy of the estimated covariance matrices, pursuant to the techniques and systems that are disclosed herein, allows a desired solution degrees-of-freedom by assigning parameters, such as damping or relative data-weighting.

Although a specific example is disclosed herein for purposes of estimating the covariance of surface-seismic tomographic residuals, and the flowcharts in the accompanying figures reference geologic structures, the skilled artisan will appreciate that the systems and techniques that are disclosed herein may be applied to estimating other covariance matrices, as well as other seismic and non-seismic data processing applications. In this manner, the systems and techniques that are disclosed herein may be applied, in general, to process any data that may be relatively smooth for most of their values and relatively rough in compact regions. As an example, in some implementations, the data may be sensor data that represent a structure of interest. In this manner, the data may be sensor data (ultrasonic data, seismic data, electromagnetic data, and so forth), simulation data or any other data that represent a geologic structure, a biological structure, a manmade structure, and so forth. In further implementations, the data may represent an observable or simulated event, such as a satellite image, a temperature distribution, a pressure distribution, a weather phenomenon, a wavefield, and so forth. Thus, many variations are contemplated, which are within the scope of the appended claims.

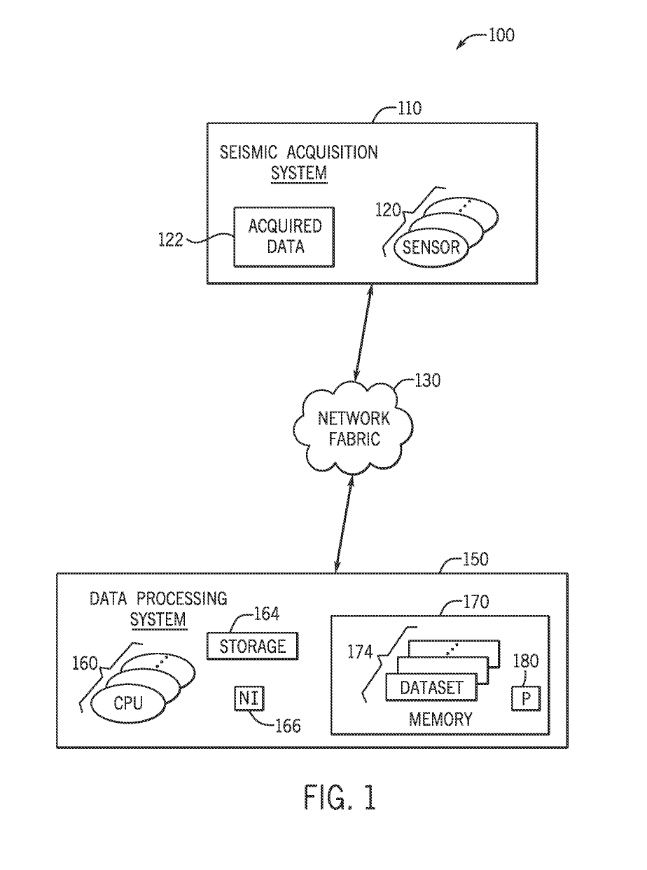

Referring to FIG. 1, in accordance with example implementations, a system 100 for acquiring and processing seismic data includes a seismic acquisition system 110. The seismic acquisition system 110 may take on numerous forms, depending on the particular implementation. For example, in accordance with some example implementations, the seismic acquisition system 110 may be a marine-based seismic acquisition system, such as an acquisition system that employs one or multiple towed seismic streamers; or a seabed-based seismic acquisition system, which includes one or more sensor cables disposed on the ocean floor. In further implementations, the seismic acquisition system 110 may be a land-based seismic acquisition system, such as a vibroseis system that employs one or multiple seismic vibrators; a well-based seismic acquisition system in which seismic sources and/or receivers are disposed in one or multiple wells; and so forth. Regardless of its particular form, the seismic acquisition system 110 includes one or multiple seismic sensors 120, which acquire data, which is due to the sensing of energy generated by at least one energy source and which corresponds at least in part to a three-dimensional (3-D) geologic structure (a multiple layer formation, for example) upon which the energy is incident.

In this regard, a given seismic sensor 120 may be, as examples, a hydrophone that acquires a pressure measurement, a geophone, which acquires a particle motion measurement; or a multicomponent seismic sensor, which acquires both pressure and particle motion measurements. For a particle motion seismic sensor, the sensor may acquire measurements indicative of particle motion among one, two or three spatial axes. FIG. 1 generally depicts data 122 acquired by the sensor(s) 120. The acquired data 122 may be pressure data, particle motion data or a combination of pressure and particle motion data (i.e., multicomponent data).

FIG. 1 further depicts a data processing system 150, which, as its name implies, processes the acquired data 122 for purposes of determining one or more properties (velocities, densities and so forth) of the surveyed 3-D geologic formation. In this manner, the acquired data 122 may be communicated to the data processing system 150 over network fabric 130 (as depicted as an example in FIG. 1), such as LAN-based, WAN-based and/or Internet-based fabric; and/or the acquired data 122 may be communicated to the data processing system 150 using numerous other communication paths or media (via magnetic storage tapes, removable storage media, and so forth), depending on the particular implementation.

In general, the data processing system 150 includes one or multiple processors, such as one or more central processing units (CPUs) 160, which are depicted in FIG. 1. In this regard, a given CPU 160 may contain one or multiple processing cores, depending on the particular application. In addition to the CPUs 160, the processing system 150 also includes a memory 170, which contains machine executable instructions, or “program instructions 180” that are executed by the CPUs 160 to process the acquired data 122 for purposes of determining property(ies) of the surveyed 3-D geologic formation. Moreover, the memory 170 may further store initial, intermediate and/or final datasets 174, which are represent the processing of the acquired data 122 in its various states, as further disclosed herein. Regardless of its particular form, the memory 170 is a non-transitory storage medium, such as a memory formed from semiconductor storage devices, optical storage devices, magnetic storage devices, and so forth, as can be appreciated by the skilled artisan. The data processing system 150 may contain other hardware components, such as non-volatile storage 164, a network interface 166 and so forth, depending on the particular implementation.

Although the data processing system 150 is depicted in FIG. 1 as being contained in a single “box” or rack, it is understood that the data processing system 150 may be distributed over several remote and/or local locations and as such, may be a “distributed processing system,” as can be appreciated by the skilled artisan.

Determining the seismic property(ies) of a 3-D geologic structure may involve solving an ill-posed linear system described by “Ax=y,” where “A” is an M-by-N matrix that is somehow “deficient,” as further disclosed herein; “x” represents an N-vector to be estimated; “y” represents an M-vector of given data; and M and N are both considerably large, such as in the range of 10⁷ to 10⁸ or greater, in accordance with example implementations.

In accordance with an example implementation, “ill-posed” refers to the y data failing to be contained in the column space of the A matrix (i.e., the failure of the data y to be contained in the span of the N columns of the A matrix) and/or a deficiency in the A matrix, such as one of the following: if the column space of the A matrix (i.e., “col[A]”) is too small then x is over-determined; if row[A]:=col[At] is too small then x is under-determined (where “t” denotes the transpose operation and “:=” denotes identity by definition); and if any direction in the row space of the A matrix (row[A]) is associated with a significantly small singular value of matrix A, then x will be very sensitive (unstable) to perturbations in the corresponding direction in col[A].

The above-described situations in which the linear system is deemed as being “ill-posed” may be summarized using the singular-value decomposition (SVD) of the A matrix, which is set forth below:

A=(U,U₀)((⊕σ,0)^{t},0)(V,V₀)^{t}=U(⊕σ)V^{t}, Eq. 1

where “(U,U₀)” represents an orthogonal (i.e., inverted by its transpose) M-by-M matrix; “U” represents an M-by-K matrix of K orthogonal left singular vectors of A (eigenvectors of AA^{t} and comprising an orthonormal basis for col[A]); 0≦K=M−M′=N−N′≦min[M,N] is the rank of A; “M′” represents the corank of A matrix; “N′” represents the nullity of A matrix; “U₀” represents an M-by-M′ matrix of M′ orthogonal left-nullspace vectors of A matrix (U₀^{t}A=0, so that col[U₀] is the left nullspace of A matrix); “(V,V₀)” represents an orthogonal N-by-N matrix; “V” represents an N-by-K matrix of K orthogonal right singular vectors of A matrix (eigenvectors of A^{t}A and comprising an orthonormal basis for row[A]); “V₀” represents an N-by-N′ matrix of N′ orthogonal right-nullspace vectors of A matrix (AV₀=0, so that col[V₀] is the right nullspace of A matrix); “⊕” represents the unary direct sum i.e., matrix with the vector operand on its diagonal; “σ” is a K-vector of singular values of A matrix (positive eigenvalues of AA^{t} and A^{t}A); and “0” represents a zero matrix of context-dependent size.

That is, the situations set forth above may be summarized by the following decompositions:

x=Vξ+V_{O}ξ₀, and Eq. 2

y=Uη+U₀η₀, Eq. 3

and their consequence:

(⊕σ)ξ=η. Eq. 4

In other words, the K-vector ξ:=V^{t}x is the information in x that may be determined; the K-vector η:=U^{t}y is the information in y that determines x; and the differential dξₖ=σₖ⁻¹dηₖ expresses the sensitivity of x to y.

Depending on the circumstances, there may not be a practical way to determine the N′-vector ξ₀, but synthetic values of x_{rand}:=V_{O}ξ₀ may be used to explore equally informed values of x (where x_{rand} is a projected random N-vector). There is no effect of the M′-vector η₀:=U₀^{t}y on x, but it measures how much of the data are non-informative.

One solution to the determinacy issues is to apply the Moore-Penrose pseudoinverse A⁺:=U(⊕σ)⁻¹V^{t}. However the sensitivity issue remains. Another issue is that the singular value decomposition costs O[max[M,N]min[M,N]²] flops. Assuming as usual, without loss of generality σₖ₊₁≦σₖ, sensitivity may be partially addressed by truncating all uses of K above, to some smaller effective rank K′, but there is no universally accepted criterion to choose K′ to reduce sensitivity while preserving desired information.

In accordance with example implementations, one approach to address (or mitigate) the above-described issues is to augment the A matrix and the y data to derive a preconditioned, well-behaved system, as set forth below:

A→((QAP⁻¹)^{t},λ(GP⁻¹)^{t})^{t}, Eq. 5

x→Px, and Eq. 6

Y→((Qy)^{t},0)^{t}, Eq. 7

where “P” represents the N-by-N preconditioner matrix for row[A] (typically controlling the shapes in and smoothness of x); “Q” represents the M-by-M preconditioner matrix for col[A] (so that Qy has reduced noise and reduced non-informative content); “λ>0” represents a damping factor (reducing the effect of singular values of A that are less than k times the corresponding singular value of G); and “G” represents an approximation of some order of derivative of x with respect to its row index, or is another “roughening” matrix (having increasing spectrum), or is the identity matrix I.

To account for remaining uncertainty, the point of view of Bayesian inference is taken, so that x is taken not as an exact solution but as the maximum-posterior-probability value given assigned prior values of uncertainty for x and the jointly preconditioned residual, as described below:

r:=y−Ax. Eq. 8

Bayes' rule states that the posterior probability of x given r is the normalized product of the likelihood of r given x with the prior probability of x.

In terms of probability distribution functions of the preconditioned variables, Bayes' rule may be written as follows:

[symbol]

[x|r]= [symbol] ᵣ[r|x] [symbol] ₀[x]/∫ . . . ∫ [symbol] ᵣ[y−Ax′|x′] [symbol] ₀[x′]dx₁′ . . . dx_{N}′. Eq. 9

In the Bayesian point of view, λ⁻²P(G^{t}G)⁻¹P^{t} represents the un-preconditioned prior solution-covariance matrix, and R=QQ^{t} represents the un-preconditioned residual covariance matrix.

In terms of (−2×) Gaussian log-probabilities, Bayes' rule may be written as follows:

(x− x̅)^{t}C⁻¹(x− x̅)=∥y−Ax∥²+λ²∥Gx∥²−y^{t}D⁻¹y, Eq. 10

where C=(A^{t}A+λ²G^{t}G)⁻¹ represents the preconditioned posterior covariance matrix; D=λ⁻²A(G^{t}G)⁻¹A^{t}+I represents the preconditioned data-covariance matrix; and x̅=CA^{t}y is the posterior mean. Norm-powers other than two may be handled using iteratively reweighted least squares.

When G^{t}G is diagonal in col[V] with representation V(⊕g)²V^{t} and if the A=U(⊕σ)V^{t} factors have been pre-computed, then relatively fast computations may be performed as C=V(⊕(σ [symbol] ²+λ²g [symbol] ²))⁻¹V^{t}, where “ [symbol] ” denotes the entry-wise power. Otherwise, the right hand side of Bayes' rule provides a quadratic form to be minimized using conjugate-gradient type numerical methods. Those with skill in the art will appreciate that there are a number of methods that one may employ to obtain the solution once the covariance matrices in λ⁻²P(G^{t}G)⁻¹P^{t} and R=QQ^{t} have been estimated. Systems and techniques are disclosed herein for purposes of estimating these covariance matrices.

Given a good estimate of the C covariance matrix, it is useful to define the posterior Fisher information matrix, which described below:

F:=∂(A x̅)/∂y^{t}=ACA^{t}. Eq. 11

Eq. 11 quantifies the amount of information that the x matrix carries about the y data. For example, the degrees of freedom may be described as follows:

N_{dof}[σ,λ]:=tr[F]. Eq. 12

The degrees of freedom depend on the ratio vector σ/λ and is invertible with respect to λ. Therefore, by orthogonalizing the col[U] contributions from two data sources of mutual weight c, the degrees of freedom may be decomposed as follows:

N_{dof}[(σ₁^{t},cσ₂^{t})^{t},λ]=N_{dof}[σ₁,λ]+N_{dof}[cσ₂,λ]=N_{dof}[σ₁,λ]+N_{dof}[σ₂,λ/c]. Eq. 13

If a certain overall N_{dof} value is targeted, the left equality of Eq. 13 may be solved for λ, and the right equality of Eq. 13 may be solved for c. That is, a certain overall degree of freedom can be produced in two steps by determining first the damping factor and secondly the data-source weighting according to Eq. 13.

Varying embodiments disclosed herein can also be applied to the prior solution-covariance matrix, but for convenience here, they will be described with regard to R.

Given an M-by-L matrix Y of measured data (e.g., in seismic tomography, the residual depth moveouts, and assuming, without loss of generality, that the data means have been subtracted), their M-by-M sample covariance matrix is R=YY^{t}/(L−1), which in some circumstances can be too large to even store, let alone compute. Moreover, the R covariance matrix may be vulnerable to sampling error (for L [symbol] M).

In accordance with an example implementation, the R covariance matrix may be applied using eigendecomposition, as described below:

R=E(⊕δ)E^{t}. Eq. 14

The above-described application may, however, be relatively costly, in terms of data space and computation time.

In accordance with example implementations, a reasonable approximation for the R covariance matrix is to assume that the E matrix is approximately equal to a matrix (called “W”), whose columns are wavelet basis functions that may be orthogonal, biorthogonal, or otherwise facilitating the inversion W⁻¹. For example, in accordance with example implementations, the wavelet basis functions may be data-independent “off-the-shelf” wavelet basis functions, which are uninformed by any datum Yₚₗ. Using this approximation, the eigenvalues δ may be approximated by the relatively inexpensively-computed variance-vector \tilde{δ}=diag[\tilde{Δ}], where \tilde{Δ}=W^{t}YY^{t}W/(L−1) denotes the putative (full computation not required) covariance matrix of an appropriately normalized wavelet-coefficient matrix WY.

There is theoretical and empirical evidence for the correlation estimates described below:

0 [symbol] |\tilde{Δ}ₘₙ|/(\tilde{Δ}ₘₘ\tilde{Δ}ₙₙ)^{1/2} [symbol] 1(m≠n), Eq. 15

even when the following holds:

|R_{pq}|/(RₚₚR_{qq})^{1/2} [symbol] 1 Eq. 16

Equation 16 may be reasonably well-approximated using the following:

R≈W(⊕\tilde{δ})W^{t}. Eq. 17

In accordance with example implementations, the aforementioned expression, R≈W(⊕\tilde{δ})W^{t} may be used to estimate covariance from only its diagonal matrix in wavelet coordinates, and this expression may be readily extended to other sparse matrix forms e.g., multi-diagonal, block diagonal or banded matrix forms.

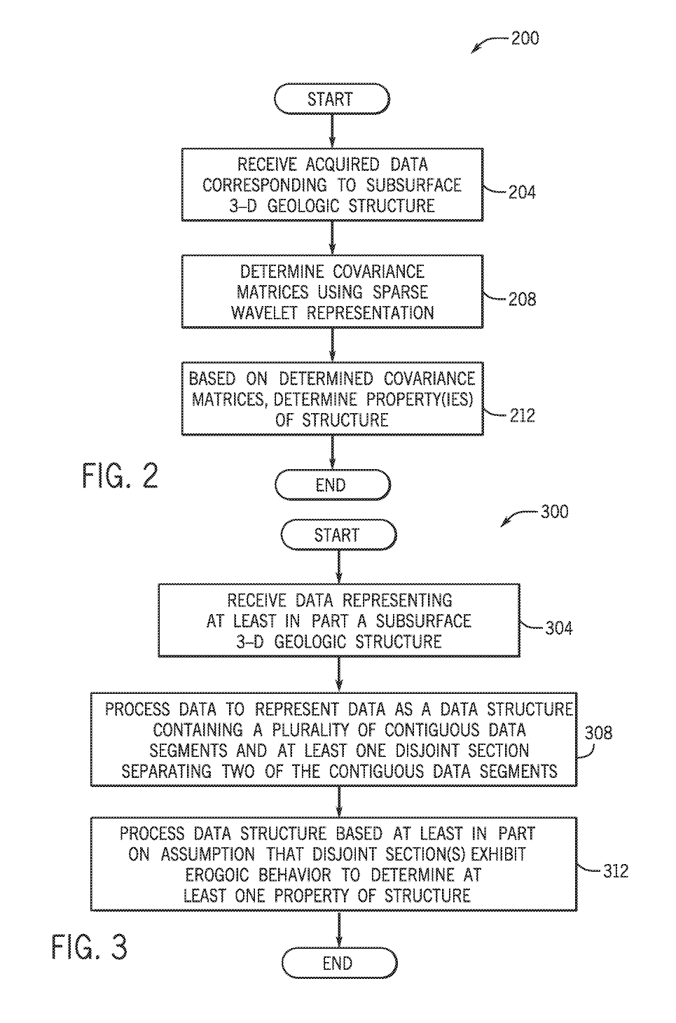

Thus, referring to FIG. 2, in accordance with example implementations, a technique 200 may be performed. Pursuant to the technique 200, acquired data (i.e., the y data) corresponding to a subsurface 3-D geologic structure is received, pursuant to block 204. Covariance matrices are determined (block 208) using a sparse wavelet representation; and based on the determined covariance matrices, one or more properties (a density and/or a velocity, as examples) of the structure are determined, pursuant to block 212.

In accordance with example implementations, the y data may be reorganized to simplify determining the covariance matrices. In this manner, one may relax the requirement that the Y columns be either L ensemble samples or L historical values of some M-vectors y, and instead, allow Y to be a re-shaping (including interpolation between common-image gathers) of a single measured data ML-vector y, under the assumption that each contiguous length-M segment (y_{Ml}, Y_{Ml+1}, . . . , y_{M(l+1)-1}) represents the y data reasonably well, whereas disjoint length-L sections (y_{Lm}, y_{Lm+M}, . . . , y_{L(m+M)-M}) mainly contain ergodic behavior.

As a more specific example, in accordance with example implementations, the acquired seismic data 122 may be a function of (as examples) source-to-sensor offset, depth, azimuth and so forth. However, it may be determined that the seismic data may be adequately represented by depth and offset. As such, the y data may be reorganized into records containing the sensor measurements, where the depth and offset correspond to columns of the record and with the measurements corresponding to different azimuths and lateral locations being treated as ergodically varying.

In accordance with some example implementations herein, “ergodic” means the probability distribution may be approached by the following sample distribution:

∫_{-∞}^{∞} . . . ∫_{-∞}^{∞}∫_{y}_{_{Lm=−∞}}^{b} [symbol] _{d}[y]dy≈L⁻¹Σₗ₊₀^{L-1}1[y_{Ml+Lm}≦b]∀m, Eq. 18

where 1[ [symbol] ] represent the indicator of statement [symbol] , i.e., “1” for true and “0” for false.

Thus, referring to FIG. 3, in accordance with example implementations, a technique 300 includes receiving (block 304) data that represent at least in part a subsurface 3-D geologic structure. The data are processed, pursuant to block 308, to represent the data as a data structure that contains a plurality of contiguous data segments and at least one disjoint section that separates two of the contiguous data segments. The data are processed (block 312) based at least in part on the assumption that the disjoint section(s) exhibit ergodic behavior to determine at least one property of the structure.

For d space coordinates one may factor the data size as M=M₁ . . . M_{d}, and in certain applications, the transform W→W₁ [symbol] . . . [symbol] W_{d} may be a Kronecker product. However, this approach may be unsuitable for data containing “mutes.” In this regard, a “mute” is a kind of data heterogeneity that refers to sensor data that have been purposely omitted, such as, for example, data acquired by a given sensor that was omitted (or “cancelled”) due to the data not satisfying a predetermined signal-to-noise ratio (SNR) threshold. The mutes may be created by interdependencies between data side lengths, such as depth and offset, for example. For example, the sensor data may be progressively more noisy with offset as the depth increases.

In accordance with example implementations, to account for mutes, the factors of an M-by-M product W=W₁ . . . W_{d} of d direct sums may be determined as follows in each coordinate a:

Wₐ=Πₐ^{t}(I [symbol] (W_{a,1}⊕ . . . ⊕W_{a,J[a]}))Πₐ, Eq. 19

where “a” represents 1, . . . d; “J[a]” represents the maximum multi-index of non-a coordinates restricted to the mute set; and “Πₐ” represents the M-by-M permutation matrix to organize the data with priority along direction a (generalizing the usual transpose operation and implemented with similar efficiency). In varying circumstances, embodiments of this nature may include that each (or one or more) transform block W_{a,j} may have a different number M_{a,j} of columns depending on the bounding of coordinate a against the mute or data gaps or other grid-heterogeneity considerations, where M_{a,1}+ . . . +M_{a,J[a]}=Mₐ is the number of columns of the direct sum, and I is the M/Mₐ-by-M/Mₐ identity.

The number \tilde{M}_{a,j} of rows of W_{a,j} need not equal M_{a,j}, as long as W_{a,j} at least has an M_{a,j}-by-\tilde{M}_{a,j} (approximate) left-inverse. In this case, the leftmost factor of Πₐ^{t} in Eq. 18 is appropriately modified in consideration that every wavelet has a prescribed spatial location.

A typical ith column w_{a,j,i} of W_{a,j} approximates the sample of the ith wavelet W_{a,j,i}[xₐ] along direction a for fixed multi-index j. Typically the W_{a,j,i}[xₐ] are dilations and shifts W_{a,j}[s^{p[i]}xₐ−q[i]] of a single mother wavelet W_{a,j}[x], where the radix s→2, exponent p[i]:=logₛi and shift q[i]:=i−s^{p[i]}; but none of these constructions are essential to the embodiments disclosed herein, which can take into account the result that the transform sparsifies the covariance matrix while permitting an accurate reconstruction.

In accordance with example implementations, Kronecker-product transforms or their generalization of Eq. 19 may be replaced by a more general multidimensional transform such as the “meshless multiscale decomposition” published by Wagner et al. 2008 (Applied and Computational Harmonic Analysis pp. 133-147), a copy of which is hereby incorporated by reference in its entirety.

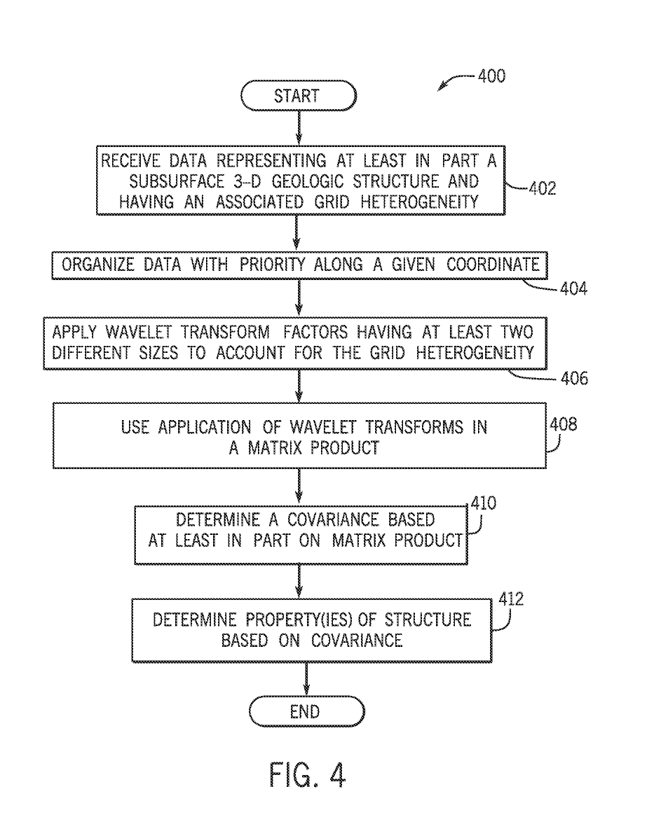

Thus, referring to FIG. 4, in accordance with example implementations, a technique 400 includes receiving (block 402) data that represent at least in part a subsurface 3-D geologic structure and having an associated grid heterogeneity such as a mute. The technique 400 includes organizing (block 404) the data with a priority along a given coordinate; and applying (block 406) wavelet-transform factors having at least two different sizes to account for the grid heterogeneity. The technique 400 further includes (block 408) application of the wavelet transforms in the form of a heterogeneity-determined matrix product; determining (block 410) a covariance based at least in part on the matrix product; and determining (block 412) one or more properties of the structure based on the determined covariance.

The data 122 may include data “gaps,” which may be due to rejected data, failed sensors, and so forth. In this manner, the data may be associated with a grid (a 2-D spatial grid or a 3-D spatial grid, as examples), such that the data 122 may contain measurements (or values) corresponding to certain points of the grid. The data gaps are due to missing measurements (or values) that may, for example, correspond to points of the grid or are “missing” in the sense that nearby values that correspond to points of the grid imply that one or more values should be present that is (or are) not present. A given gap may be formed, for example, from one or multiple missing measurements in a given interval along a particular coordinate. In some implementations, “internal” data gaps, or datum-rejects, (i.e., missing data not associated with a given coordinate boundary) may be taken into account by weighting the available or retained data by weight vectors ρₐ so that ∥W_{a,j}(ρₐ [symbol] y)∥²≈∥ρₐ [symbol] y∥² well approximates the line integral of y² along coordinate a and across non-a coordinates for fixed multi-index j (where [symbol] denotes the Hadamard-Schur or entry-wise product). As an example, the values ρ_{a,p} may be divided into factors that are proportional to Mₐ^{-1/2} over uniform intervals along direction a and are proportional to (Mₐ/N_{g})^{-1/2} where there is a gap of N_{g} data values.

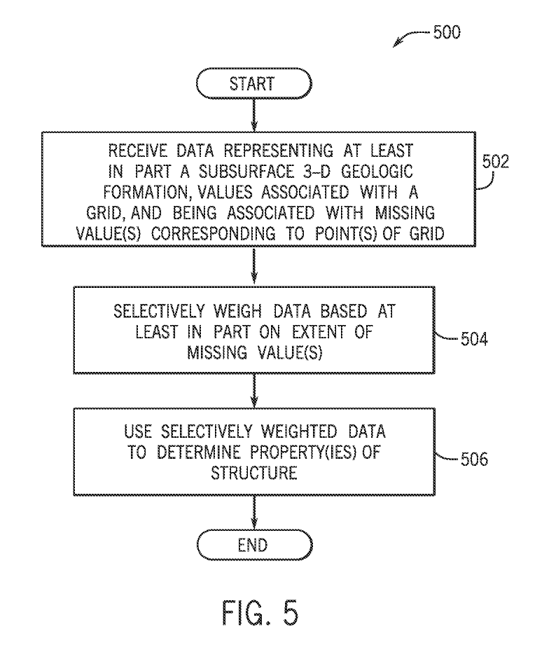

Thus, referring to FIG. 5, in accordance with an example implementation, a technique 500 includes receiving (block 502) data that represent at least in part a 3-D geologic formation. In particular, the data represent values associated with certain points of a grid and are further associated with one or more missing values. The technique 500 includes selectively weighting (block 504) the data based at least in part on an extent of the missing value(s) and using (block 506) the selectively weighted data to determine one or more properties of the structure.

One advantage of various implementations disclosed herein relates to the data-compression qualities of wavelet transforms, especially when the operand is relatively “smooth” throughout most of its domain and “rough” mainly in more-or-less isolated regions. Therefore, varying implementations disclosed herein may apply not only to covariance estimation, but also for estimating more or less general kernels T, even singular ones, in multidimensional operations, as described below:

∫ . . . ∫T[y,y′]f[y′]dy₁′ . . . dy_{M}′, Eq. 20

Moreover, as those with skill in the art will appreciate, the techniques disclosed herein may be applied also outside seismic exploration to benefit any application requiring estimating multivariate covariance with limited and/or noisy data, especially data that behave like polynomials with respect to certain coordinates except within compact coordinate sub-regions. Additionally, techniques disclosed herein may be applied to estimate data covariance and correlation, quantify propagation of uncertainty to derived quantities, generate random realizations etc.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While the discussion of related art in this disclosure may or may not include some prior art references, applicant neither concedes nor acquiesces in the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method comprising:
receiving data representing at least in part a structure of interest;
processing the data in a processor-based machine to represent the data as a data structure comprising a plurality of contiguous data segments and at least one disjoint section separating two of the contiguous data segments; and
processing the data structure based at least in part on the at least one disjoint section exhibiting ergodic behavior to determine at least one property of the structure.

2. The method of claim 1, wherein receiving the data comprises receiving data representing at least in part sensed energy attributable to energy from at least one energy source being incident upon the structure of interest.

3. The method of claim 1, wherein receiving the data comprises receiving seismic data representing at least in part sensed energy attributable to energy from at least one energy source being incident upon a geologic structure of interest.

4. The method of claim 1, wherein processing the data structure to determine at least one property of the structure comprises processing the data structure to determine at least one of a velocity or a density of the structure.

5. The method of claim 1, wherein processing the data structure comprises processing the data structure based at least in part on an assumption that the probability distribution of the contiguous data segments is approximately the same as a sample distribution of the contiguous data segments.

6. The method of claim 1, wherein processing the data structure comprises determining a diagonal representation of a covariance of at least one tomographic residual.

7. A system comprising:
an interface to receive data being associated with a grid having a plurality of coordinates, the data having at least one variation on the number of indices for an associated coordinate of the plurality of coordinates such that the data have an associated grid heterogeneity; and
a processor to process the data to:
organize the data with a priority along a given coordinate of the plurality of coordinates;
apply a plurality of wavelet-transform factors having at least two different sizes to the data to account for the grid heterogeneity;
use the application of the plurality of wavelet transforms in a matrix product; and
determine a covariance based at least in part on the matrix product.

8. The system of claim 7, wherein the data represent at least in part sensed energy attributable to energy from at least one energy source being incident upon a structure of interest.

9. The system of claim 7, wherein the processor is adapted to determine the matrix product using the wavelet-transform factors in lieu of eigenvector matrices of a data covariance matrix such that the wavelet-transform factors approximate the eigenvector matrices.

10. The system of claim 7, wherein the processor is adapted to apply a permutation matrix to organize the data with a priority along a given coordinate of the plurality of coordinates.

11. The system of claim 7, wherein the data represent at least in part a structure of interest, and the processor is adapted to process the data to determine at least one property of the structure of interest.

12. The system of claim 11, wherein the property comprises a velocity or a density.

13. A method comprising:
receiving data representing at least in part a structure of interest, the data representing at least in part values associated with a grid and being associated with at least one missing value; and
processing the data in a processor-based machine to determine at least one property of the structure of interest, the processing comprising selectively weighting the data corresponding to the values based at least in part on an extent of the at least one missing value.

14. The method of claim 13, wherein selectively weighting the data comprises weighting the data so that for a given line integral, a mean square value along a coordinate compensates for the missing value.

15. The method of claim 13, wherein receiving the data comprises receiving seismic data representing at least in part sensed energy attributable to energy from at least one energy source being incident upon a geologic structure of interest.

16. The method of claim 13, wherein receiving the data comprises receiving data representing at least in part sensed energy attributable to energy from at least one energy source being incident upon the structure of interest.

17. The method of claim 13, wherein processing the data comprises determining a velocity or density of the structure.

18. The method of claim 13, wherein selectively weighting the data comprises selectively weighting the data based at least in part on a number of the at least one missing value over a given interval.

19. The method of claim 13, wherein processing the data to determine at least one property of the structure of interest comprises processing the data to determine a covariance matrix.

20. The method of claim 13, wherein processing the data comprises determining a velocity or a density of the structure of interest.
